(19) United States
(12) Patent Application Publication
(10) Pub. No.: US 2014/0109721 A1
(43) Pub. Date: Apr. 24, 2014

(54) PROCESS FOR THE PRODUCTION OF A PINNED END FITTING OF A LONGITUDINAL PART, END FITTING THUS OBTAINED

(71) Applicant: EPSILON COMPOSITE, Gaillan En Medoc (FR)

(72) Inventors: Noel CARRERE, Cestas Cedex (FR); Dominique NOGUES, Hourtin (FR)

(73) Assignee: EPSILON COMPOSITE, Gaillan En Medoc (FR)

(21) Appl. No.: 14/057,165

(22) Filed: Oct. 18, 2013

(30) Foreign Application Priority Data
Oct. 18, 2012 (FR) 1259921

(51) Int. Cl. F16C 7/02

(52) U.S. Cl. CPC F16C 7/02
USPC 74/581; 29/428

(57) ABSTRACT

A process for the production of an end fitting attached to a body in the form of a longitudinal part such as a tube, with the end fitting including a yoke with two arms (18-1, 18-2), each equipped with a hole (20-1, 20-2) designed to work with a pin, is characterized in that at least one area (34) of less rigidity is made in the end fitting, in the area located upstream from the holes.

### FIELD OF THE INVENTION

This invention relates to a process for the production of a pinned end fitting of a longitudinal part such as a tube, more particularly a connecting rod in a structure with a static or moving opening, of a frame, of an aircraft or of a ship.

The invention also covers the end fitting that is thus obtained.

### BACKGROUND OF THE INVENTION

In any structure, individual elements that pull and/or push, such as connecting rods or tightening straps, are designed to take up major forces with maximum safety and minimum weight.

For example, in aeronautics and more particularly in the construction of aircraft, the connection between the wings and the fuselage is an area in which the absorption of forces is particularly complex.

For this purpose, a mesh of tie rods, also called connecting rods, which are subjected to compressive forces, tensile forces, and even buckling forces in an alternating way and with cycles that are extremely high in number, is provided.

These connecting rods are connected to other elements of the structure by pin connections.

It is consequently understood that the pin connection is subjected to these same cycles.

In aeronautics, the drive to reduce weight is actually a constant because weight leads to an increased consumption of fuel or a loss of payload for the same consumption, which is detrimental in any case. In addition, aircraft manufacturers also seek to improve performances relative to the mechanical strength for the same weight, and even a reduced weight.

Also, the connecting rods are made of strong and light materials such as metal alloys or composite materials, and more particularly of carbon fibers.

In addition, by using a suitable resin, by resorting to the process for manufacturing by pultrusion, by adjusting the orientations of fibers and with enhanced manufacturing know-how, the body of connecting rods that are made exhibits extremely high mechanical characteristics with an extremely low weight.

The manufacturing of the “tubular part” of a connecting rod is industrialized, and the product that is obtained is adapted to aeronautical conditions.

At the level of the connection of these tubular products to the structure, the presence of a yoke located in the end fitting mounted on the ends of said tubular part has been adopted.

When the end fitting is attached to the connecting rod body, it is generally made from a light metal alloy such as aluminum by molding and/or machining. The yoke is factory-mounted with the body of the end fitting, itself designed to be encased and connected to the connecting rod body. The connection is preferably of the gluing type, but can also be achieved by screwing, riveting, welding, pinning or bolting.

The end fitting that is mounted with a pin on the structure is subjected to concentrations of stresses on very limited areas of the mounting surfaces around the axis, and the alternating tensile forces and compressive forces lead to premature fatigue.

Because the pin is subjected to bending as indicated previously in the description, the ends of the pin rest on very localized areas of the holes made in the yoke, creating a non-homogeneous distribution of the stresses along a generatrix of contact in these localized areas.

This concentration of stresses on the surface and in the material in the immediate proximity of the holes is detrimental to the quality of the mechanical mounting and to the mechanical strength of the unit, and in particular to its fatigue strength and its static tensile strength. The forces are not relayed onward in the desired directions, each of the component parts of the part does not work in an optimal way in response to the stresses, and all of the material is not stressed.

This localized concentration of stresses can rapidly lead to incipient cracks and therefore, in the long run, to failure.

Because of the very strict safety rules that can be encountered in works of art, buildings, moving vehicles or, in the aeronautical field, such elements, integrated in the structure, are closely monitored vital parts.

In the case of a detection of such degradations, the element is changed, which affects at least the high maintenance costs, but in the case of an approximate monitoring, the risk of failure is not ruled out.

### SUMMARY OF THE INVENTION

This invention also, has the object of remedying this problem of crack initiation by concentrating stresses in a part that is subjected to repeated tensile/compressive stresses in a mounting with a yoke and a pin, in particular to limit the concentrations of stresses on the inside surface of the holes and the ridges.

### BRIEF DESCRIPTION OF THE DRAWINGS

This invention is now described in application to connecting rods of the structure of an aircraft, without this example being, in any manner, limiting.

The preferred embodiment is illustrative, and drawings are attached to explain this description, with the figures of these drawings showing:

FIG. 1: a perspective view of one end of an aeronautical connecting rod with an attached end fitting, being mounted by a pin,

FIG. 2: a lateral front view of the connecting rod of FIG. 1, with a diagrammatic representation of the stresses and consequences,

FIG. 3: a view of an implementation of the process and the attached end fitting that is obtained.

### DETAILED DESCRIPTON OF THE INVENTION

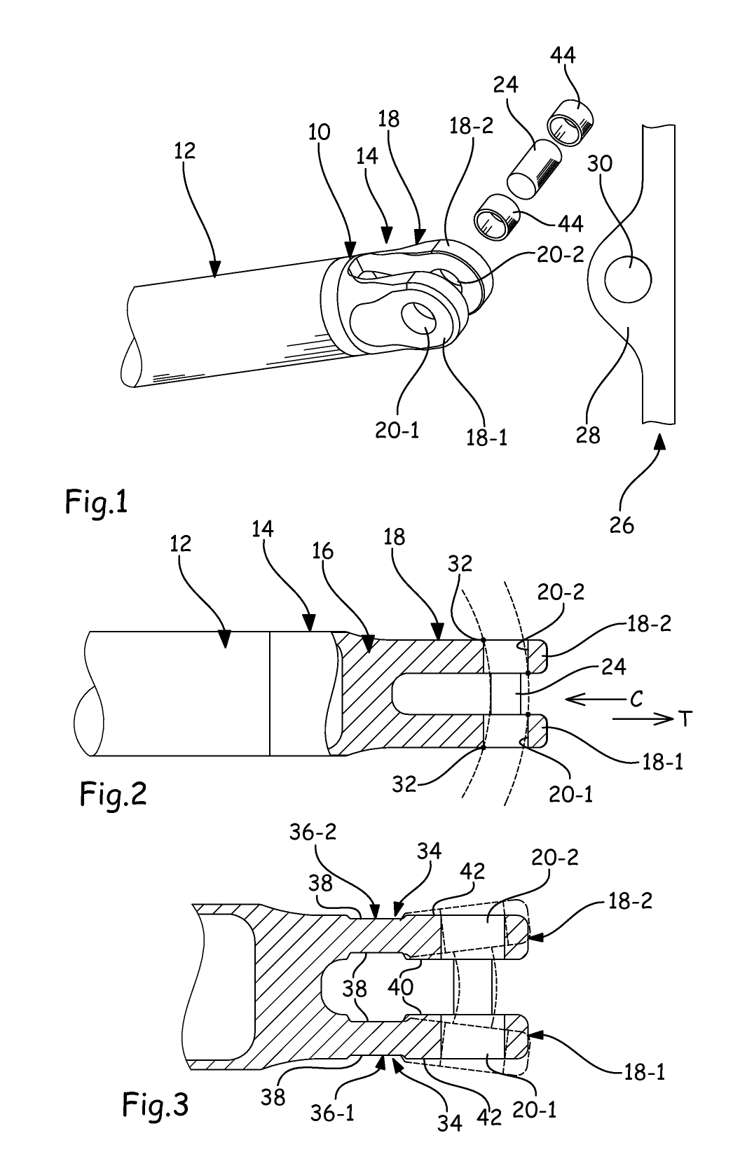

In FIG. 1, a tubular body is partially shown, in this case an aeronautical connecting rod 10 that consists of a connecting rod body 12 and two end fittings 14 attached to the ends of said body 12.

The connecting rod 10 is made of light and very strong materials, and preferably of composite materials, in particular from high-module carbon fibers and epoxy resin fibers, with a process for manufacturing by pultrusion that makes it possible to obtain a connecting rod body of high precision and with elevated mechanical characteristics.

In this embodiment, the end fitting 14 is made of a metal material of the light alloy type such as aluminum. This end fitting 14 comprises an end fitting body 16 of a shape mated to that of the end of the body 12 of the connecting rod, in this case with a circular cross-section.

At the opposite end, the attached end fitting 14 comprises a yoke 18 with two arms 18-1, 18-2, each equipped with a hole 20-1, 20-2 designed to receive a pin 24 as will be explained later.

The invention defines pin as a shaft, a bolt, or any other similar part.

The free end of the connecting rod body 12 receives the end fitting 14 by interlocking and gluing, with this connection not being part of this invention.

The connecting rod is thus designed for being connected to a structure 26 that is equipped with a handle 28 having a hole 30 designed also to receive the same pin 24 mentioned above. Said handle 28 is housed between the two arms 18-1, 18-2 of the yoke 18.

In FIG. 2, it is noted that when the connecting rod 10 is subjected to tensile forces T and compressive forces C, a concentration of stresses occurs starting from the inside surface of the hole at least, which can lead to an appearance of cracks or at least an appearance of incipient cracks.

The pin 24 curves under the forces and comes to rest on areas 32 of limited reach within the holes 20-1, 20-2, areas 32 that take up all of the forces exerted, which causes the stress concentration phenomena. This is all the more critical the greater the play in the hole, and the pin is relatively flexible.

This non-homogeneous distribution therefore causes stress concentration peaks, which are detrimental to fatigue life, the material around the most stressed area then being less stressed and under-used.

On the handle 28 of the structure 26, the hole 30 undergoes in a much more limited way these stress concentration phenomena because it is located in the median area of the pin 24, at the low or high point of the deformed part that, during the micro-bending of the pin, is the least deformed.

In broken lines and in a way accentuated for clarity of the drawing, FIG. 2 shows the deformations of the pin 24 under the effects of the tensile forces.

So as to solve the problem of stress concentration and of generating cracks on these concentration points, the process according to this invention provides for producing at least one area 34 of minimum rigidity in the end fitting 14 upstream from said holes 20-1, 20-2.

More specifically, an area 34 of less rigidity is made in at least one arm 18-1, 18-2 of the yoke 18.

This area 34 of less rigidity is located essentially at the foot of yoke 18.

This area 34 of less rigidity makes it possible for an arm 18-1, 18-2 to bend and to curve toward the outside.

According to the invention, the deformation of an arm 18-1, 18-2 is perfectly programmed and controlled for the design of the area 34 of less rigidity.

Also, thanks to a suitable concept of the area 34 of less rigidity, the holes 20-1, 20-2 are oriented angularly under the action of the bending of arms 18-1, 18-2, and the longitudinal axis of each hole 20-1, 20-2 is oriented in a way that is very close to the orientation of the axis of the pin 24 that passes through them.

Thanks to the programmed deformation of the arms 18-1, 18-2, the distribution of the stresses will be more homogeneous between the pin 24 and the holes 20-1, 20-2 along the contact generatrix, and in the material around the holes 20-1, 20-2, because the surface of the mounting is greatly improved.

According to the invention, an area 34 of less rigidity consists of at least one thickness reduction 36-1, 36-2 of an arm 18-1, 18-2 of the yoke 18.

In an embodiment that is preferred and illustrated by FIG. 3, at least one thickness reduction 36-1, 36-2 of each arm 18-1, 18-2 of the yoke 18 is carried out.

Each thickness reduction 36-1, 36-2 is carried out between the hole 20-1, 20-2 of each arm 18-1, 18-2 of the yoke 18 and the end fitting body 16.

Still in a preferred embodiment, the thickness reductions 36-1, 36-2 are identical to each of the arms 18-1, 18-2 so as to ensure an identical mechanical response of each of these two arms.

However, in an aircraft structure that is taken up, for example, the deformations linked to the compressive and tensile forces are also combined with buckling phenomena, although the deformations of the pin 24 under these combined deformations are therefore not necessarily symmetrical to each of the arms 18-1, 18-2, and each of them is therefore to be able to respond proportionally to the deformation in such a way as to limit the concentration of stresses by preserving the best alignment possible of the axis of each hole 20-1, 20-2 with that of the pin 24.

Consequently, the invention also covers other embodiments, not shown in the figures, making it possible to ensure a different response of each of the two arms 18-1, 18-2 with tensile forces, compressive forces and bending forces that are specific to each of them.

In these other embodiments, a thickness reduction 36-1, 36-2 is carried out on a single arm 18-1, 18-2 of the yoke 18, or the thickness reductions 36-1, 36-2 carried out on each of the arms 18-1, 18-2 are not identical.

Next, as illustrated in FIG. 3, each thickness reduction 36-1, 36-2 takes the form of at least one detachment of material 38 carried out in the inside surface 40 and/or the outside surface 42 of the arm 18-1, 18-2 that receives said surface.

In a preferred embodiment and so as to make it possible for an arm 18-1, 18-2 to bend and to curve toward the outside, each thickness reduction 36-1, 36-2 is not produced symmetrically on the inside surface 40 and the outside surface 42 of the arm 18-1, 18-2 that receives said surface.

For this purpose, each thickness reduction 36-1, 36-2 comprises only one detachment of material 38 on the inside surface 40 of the arm 18-1, 18-2 that receives said surface, or a larger detachment of material 38 on the inside surface 40 of the arm 18-1, 18-2 that receives said surface than the detachment of material 38 on the outside surface 42 of this arm.

However, the invention also covers another embodiment that makes it possible, for example, to respond to micro-bending caused by tensile forces and/or compressive forces on each one of the two arms itself if the forces are essentially identical in traction and in compression, and in which each thickness reduction 36-1, 36-2 is carried out symmetrically on each inside surface 40 and outside surface 42 of an arm 18-1, 18-2.

In this other embodiment, each thickness reduction 36-1, 36-2 comprises a detachment of material 38 that is identical on each inside surface 40 and outside surface 42 of the arm 18-1, 18-2 that receives said surface.

In a general manner in this invention, because of the presence of an area 34 of less rigidity, each arm 18-1, 18-2 can deform under the stress of the pin during alternating tensile/compressive stress cycles and can minor these deformations.

An improved contact along the contact generatrix between the holes 20-1, 20-2 and the pin 24 is thus obtained under bending, although the forces are transmitted in a more distributed way over the inside surface of the holes 20-1, 20-2.

The authorized deformation of each arm 18-1, 18-2 is calculated to correspond to the deformed part of the pin 24, this over the entire range of the tensile and compressive forces considered for the connecting rod 10 having this end fitting 14.

It should be noted that the materials that constitute the yoke 18 and the pin 24 can be—and often are—different.

The curve of deformation under forces of the pin 24 is therefore different from that of the yoke 18; it is therefore necessary to take it into account finding a compromise of the deformed parts in particular so that during maximum forces, the contact surface is the largest.

It is also noted that when such end fittings 14 are produced, intermediate rings 44 arranged in the holes 20-1, 20-2 that receive the pin 24 can be provided. These rings 44 are inserted between the inside walls of the holes 20-1, 20-2 and the pin 24 and are immobilized in the hole by being clamped, for example.

The process according to this invention is then applied in exactly the same way.

In the calculation studies, it is understood that the strength in the area of less rigidity is greater than the forces to which the connecting rod 10 is subjected, with the object being to create a deformation area and not to embrittle the connection.

The invention also covers the end fitting 14 obtained by the implementation of the process.

This invention therefore finds a major advantage in this particular aeronautical application that has numerous specific stresses, but the process can be applied to any field where tie rods with attached or factory-mounted end fittings are highly stressed.

Such yoke end fittings mounted with a pin can be applied in links of vehicle drive trains aimed at achieving high performance or making handle/rigging screw hitching in the riggings of navigating structures or any parts of load-bearing structures, assemblies or frames.

1. Process for the production of an end fitting (14) attached to a body (12) in the form of a longitudinal part such as a tube, with said end fitting comprising a yoke (18) with two arms (18-1, 18-2), each equipped with a hole (20-1, 20-2) designed to work with a pin (24), characterized in that at least one area (34) of less rigidity is produced in said end fitting (14) upstream from said holes.

2. Process for the production of an end fitting (14) attached to a body (12) according to claim 1, wherein an area (34) of less rigidity is produced on at least one arm (18-1, 18-2) of the yoke (18).

3. Process for the production of an end fitting (14) attached to a body (12) according to claim 2, wherein an identical area (34) of less rigidity is produced on each arm (18-1, 18-2).

4. Process for the production of an end fitting (14) attached to a body (12) according to claim 2, wherein an area (34) of less rigidity is not produced symmetrically to the inside surface (40) and the outside surface (42) of the arm (18-1, 18-2) that receives said surface.

5. Process for the production of an end fitting (14) attached to a body (12) according to claim 1, wherein an area (34) of less rigidity consists of at least one thickness reduction (36-1, 36-2) of an arm (18-1, 18-2) of the yoke (18).

6. Process for the production of an end fitting (14) attached to a body (12) according to claim 5, wherein each thickness reduction (36-1, 36-2) takes the form of at least one detachment of material (38) made in the inside surface (40) and/or the outside surface (42) of the arm (18-1, 18-2) that receives said surface.

7. Process for the production of an end fitting (14) attached to a body (12) according to claim 6, wherein each thickness reduction (36-1, 36-2) comprises only a detachment of material (38) on the inside surface (40) of the arm (18-1, 18-2) that receives said surface, or a larger detachment of material (38) on the inside surface (40) of the arm (18-1, 18-2) that receives said surface than the detachment of material (38) on the outside surface (42) of this arm.

8. Aeronautical connecting rod comprising a body (12) and at least one end fitting (14) according to claim 1.

9. Process for the production of an end fitting (14) attached to a body (12) according to claim 3, wherein an area (34) of less rigidity is not produced symmetrically to the inside surface (40) and the outside surface (42) of the arm (18-1, 18-2) that receives said surface.
